(19) United States
(12) Patent Application Publication
(10) Pub. No.: US 2017/0363213 A1
(43) Pub. Date: Dec. 21, 2017

(54) Valve device in a motor vehicle

(71) Applicant: Continental Automotive GmbH, Hannover (DE)

(72) Inventors: Rainer Johannes MONTIGNY, Bad Soden (DE); Stefan KOPP, Bruchkoebel (DE)

(21) Appl. No.: 15/536,763

(22) PCT Filed: Dec. 15, 2015
(86) PCT No.: PCT/EP2015/079823

§ 371 Date: Jun. 16, 2017

(30) Foreign Application Priority Data
Dec. 19, 2014 (DE) 10 2014 226 732.3

(51) Int. Cl. F16K 1/22; F16K 31/04; F02D 9/10

(52) U.S. Cl. CPC F16K 1/224; F02D 9/1065; F16K 31/047

(57) ABSTRACT

A valve device in a motor vehicle including a housing; a flow passage arranged in the housing; a flap arranged in the flow passage for closing the flow passage, wherein the flap is secured on an axle, and the axle is rotatably mounted in the housing, and can be driven by an electric motor via a gear unit; and a valve seat arranged in the flow passage, with which valve seat the flap is in contact in a closing position, wherein the axle penetrates the flap at an angle. The part of the axle located in the flow passage has a smaller diameter than in the area of the bearing on the side of the gear unit.

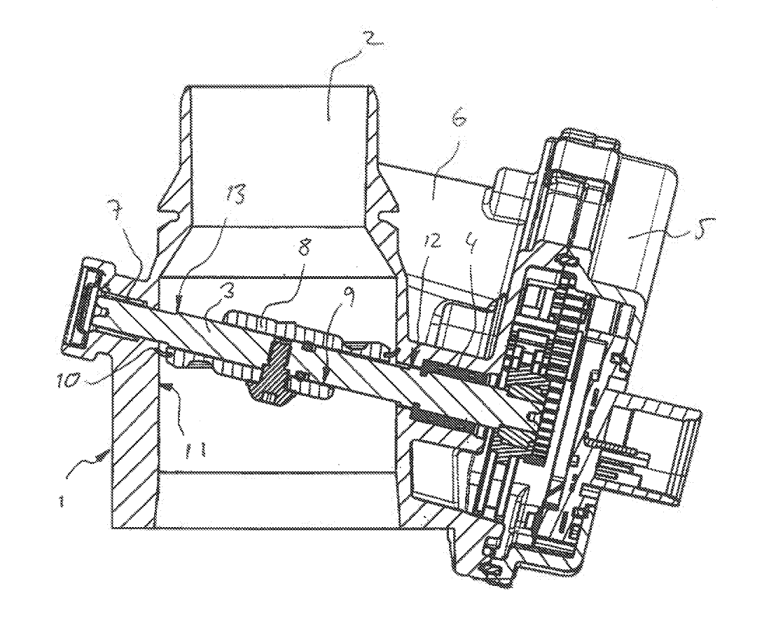

### CROSS-REFERENCE TO RELATED APPLICATIONS

This is a U.S. national stage of application No. PCT/EP2015/079823, filed on 15 Dec. 2015, which claims priority to the German Application No. 10 2014 226 732.3 filed 19 Dec. 2014, the content of both incorporated herein by reference.

### BACKGROUND OF THE INVENTION

### 1. Field of the Invention

The invention relates to a valve device in a motor vehicle, having a flow channel arranged in a housing. A flap is arranged in the flow channel and serves to close off the flow channel. The flap is fastened on a spindle and the spindle is mounted rotatably in the housing and can be driven by an electric motor via a gear mechanism. A valve seat is arranged in the flow channel. The flap is in contact with the valve seat in the closed position, the spindle penetrating the flap at an angle.

### 2. Related Art

Valve devices are used, for example, as throttle flap connectors for the air mass control of combustion engines or in fuel cell systems. Due to the penetration of the flap by the spindle at an angle and the related oblique position of the spindle in the flow channel, spindles arranged in such a manner require a larger structural space than spindles arranged in a right-angled manner in the flow channel. Reduction of the necessary structural space through a decrease in the oblique position of the spindle is limited due to the flap formation. In particular due to the seal arranged on the radially circumferential edge of the flap, relative to which the spindle has to have a certain spacing, a reduction in the oblique position is limited.

### SUMMARY OF THE INVENTION

It is an object of the present invention to provide a valve device in which a spindle, which extends in an oblique manner in the flow channel, requires a structural space that is as small as possible.

According to an aspect of the invention, this object may be achieved by that part of the spindle situated in the flow channel having a smaller diameter than the part of the spindle situated in the region of the bearing on the gear-mechanism side.

The reduction of the spindle diameter in the flow channel makes possible the arrangement of a flap with a relatively small thickness and allows a relatively slight oblique position of the spindle in the flow channel. In this way, the valve device, according to an aspect of the invention, requires a relatively small structural space along the extent of the flow channel. Consequently, the housing of the valve device can be relatively small in this direction and thus of a relatively simple and relatively low-cost design.

A further reduction of the required structural space along the extent of the flow channel can be achieved if the diameter of the spindle is further reduced in the direction of the bearing that is remote from the gear mechanism, in particular beyond the flap. With this refinement, the spindle has the smallest diameter in the region of the second bearing, which diameter allows the use of a relatively small bearing and thus likewise contributes to the reduction of the necessary structural space. The enlargement of the spacing from the flap to the shell surface of the spindle, which results from the diameter reduction, has a further advantage which has an influence on the seal that can be used. For a good sealing action, seals with projecting sealing lips are significantly more effective than simple O-ring seals. Due to the spatial extent of the sealing lip on the wall of the flow channel, the use of such seals in the case of a slight oblique position of the spindle was hitherto problematic. With the advantageous refinement of the present invention, it is now possible to use seals with sealing lips, even if the spindle has a slight oblique position.

### BRIEF DESCRIPTION OF THE DRAWINGS

The invention will be discussed in more detail on the basis of an exemplary embodiment.

The single FIGURE shows, in section, a valve device according to an embodiment of the invention.

### DETAILED DESCRIPTION OF THE PRESENTLY PREFERRED EMBODIMENTS

The valve device for a motor vehicle in the FIGURE includes a housing 1, having a flow channel 2, which is arranged in the housing and which serves for the through-flow of a fluid. In the present case, an air flow through the valve device is controlled. In the flow channel 2, there is arranged a spindle 3 mounted on both sides in the housing 1. A first bearing 4 is situated on that side of the housing 1 on which a gear mechanism 5 is arranged. The gear mechanism 5 is connected on the output side to the spindle 3, and on the input side to an electric motor (not shown) which is housed in a separate chamber 6 of the housing 1. A second bearing 7 for the spindle 3 is situated on that side of the flow channel 2 opposite to the gear mechanism 5. On the spindle 3, there is arranged a flap 8 that has a bore 9 through which the spindle 3 extends. The flap 8 is fastened on the spindle 3, by being screwed to the spindle 3. The flap 8 further has a radially circumferential edge on which there is arranged a seal 10. In the illustration shown in the FIGURE, the flap 8 is in the closed position, such that the seal 10 interacts with the region of the flow channel 2 acting as a valve seat 11 and completely closes off the flow channel 2. The spindle 3 has the largest diameter in the region of the first bearing 4. The spindle 3 has a first shoulder 12 between the first bearing 4 and the flap 8, so that the part of the spindle 3 situated in the flow channel 2 has a smaller diameter than the part of the spindle 3 situated in the region of the first bearing 4 on the gear-mechanism side. Further along, the spindle 3 has a second shoulder 13 beyond the flap 8, as a result of which the spindle 3 has a further reduced diameter in the region of the second bearing 7. As a result, the second bearing 7 is smaller than the first bearing 4. On account of the relatively large spacing between the flap 8 and the shell surface of the spindle 3 due to the reduced diameter, the seal 10 is a sealing ring with a sealing lip, wherein the sealing lip in the region of the second shoulder 13 in the flow channel extends in the direction of the spindle 3.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-2. (canceled)

3. A valve device in a motor vehicle, the valve device comprising:
a housing;
a flow channel is in the housing;
a flap arranged in the flow channel, the flap being configured to close off the flow channel;
a gear mechanism;
a spindle on which the flap is mounted, the spindle being mounted rotatably in the housing and being drivable by an electric motor via the gear mechanism the spindle penetrating the flap at an angle;
a first bearing arranged on a side of the housing proximate the gear mechanism; and
a valve seat arranged in the flow channel such that the flap is in contact with the valve seat when the flap is in the closed position,
wherein the spindle has a smaller diameter where it is situated in the flow channel than where it is situated in a region of the first bearing.

4. The valve device as claimed in claim 3, further comprising a second bearing arranged remote from the gear mechanism and beyond the flap, wherein the diameter of the spindle is further reduced in the direction of the second bearing.
